(19) United States
(12) Patent Application Publication
(10) Pub. No.: US 2021/0281880 A1
(43) Pub. Date: Sep. 9, 2021

(54) Video Based Point Cloud Codec Bitstream Specification

(71) Applicant: Telefonaktiebolaget LM Ericsson (PUBL), Stockholm (SE)

(72) Inventor: Lukasz Litwic, Gdansk (PL)

(21) Appl. No.: 17/259,262

(22) PCT Filed: Jul. 8, 2019
(86) PCT No.: PCT/EP2019/068270

§ 371 Date: Jan. 11, 2021

Related U.S. Application Data
(60) Provisional application No. 62/696,590, filed on Jul. 11, 2018.

(51) Int. Cl. H04N 19/597; H04N 19/184; H04N 19/70

(52) U.S. Cl. CPC H04N 19/597; H04N 19/174; H04N 19/70; H04N 19/184

(57) ABSTRACT

A method by a transmitter for encoding a video image includes combining a geometry image and a texture image associated with a single point cloud into a video frame. The video frame including the geometry image and the texture image are encoded into a video bitstream, and the video bitstream is transmitted to a receiver.

### TECHNICAL FIELD

This invention relates to video encoding. In particular, but not exclusively, this invention relates to the encoding of point-cloud data in a video frame.

### BACKGROUND

Point clouds are data sets that can represent 3D visual data. Point clouds span several applications. Therefore, there is no uniform definition of point cloud data formats. A typical point cloud data set contains several points which are described by their spatial location (geometry) and one or several attributes. The most common attribute is color. For applications involving 3D modeling of humans and objects, color information is captured by standard video cameras. For other applications, such as automotive LiDAR scans, there could be no color information. Instead, for instance, a reflectance value would describe each point.

For immersive video applications, it is foreseen that point cloud data may be used to enhance immersive experience by allowing a user to observe objects from all angles. Those objects would be rendered within immersive video scenes. For communication services, point cloud data could be used as a part of a holoportation system, where a point cloud could be used to represent captured visualization of people on each side of a holoportation system.

In both main examples, point cloud data resembles traditional video in a sense that it captures a dynamically changing scene or object. Therefore, one attractive approach to deal with compression and transmission of point clouds has been based on leveraging existing video codec and transport infrastructure. This is a feasible approach given that a point cloud frame can be projected into one or several 2D pictures: geometry pictures and texture pictures. Several pictures per a single point cloud frame may be required to deal with occlusions or irregularities in captured point cloud data. Depending on application it may be required that point cloud geometry (spatial location of points) are reconstructed without any error.

In the current MPEG work on point cloud codecs, such an approach is used. A single point cloud frame is projected into two geometry images and two corresponding texture images. One occupancy map frame defines which blocks (according to a predefined grid) are occupied with the actual projected information and which are empty. Additional information about projection is also provided. However, the majority of information is in texture and geometry images and this is where most compression gains can be provided.

The current approach considered by MPEG treats geometry and texture as separate video sequences and uses separate video substreams to carry the information. The rationale for this approach is that there is little redundancy that can be exploited between geometry and texture data.

However, although geometry and texture are created separately, for a reconstruction process both are required to compose a reconstructed point cloud. In addition, for a single point cloud frame, there are two geometry and two texture ges created: a, so called, near projection; and a far projection. In total, in order to reconstruct a single point cloud frame, one requires to decode all four video images. It is possible to drop the far projection images and still be able to reconstruct a point cloud frame but at a loss of quality. For lossless coding, the images also contain a patch of data that represents points missed during the projection from 3D point cloud to 2D images.

The current consideration for the organization of the point cloud codec bitstream is that it interleaves payloads for video substreams. Currently substreams are defined for Group of Frames, which defines the size of a video sequence (in terms of corresponding point cloud frames) that is set by the encoder. The payloads for the substreams are appended one after another. Currently, the approach organizes the bitstream as follows:
GOF (GroupOfFrames) header
GOF geometry video stream
GOF occupancy map & auxiliary info
GOF texture video stream

An alternative approach includes not creating a standalone bitstream specification for point cloud codec but instead leveraging existing transport protocols such as ISOBMFF to handle the substreams. In such an approach, substreams can be represented by independent ISOBMFF tracks.

There currently exist certain challenge(s). While the current arrangement is quite flexible since it allows extending into multiple streams depending on application, this comes with some potential disadvantages. For example, when dealing with two or more video streams, a PCC decoder needs to be handling both video decoding dependencies in the underlying video streams as well as composition dependencies when reconstructing a point cloud frame. Video stream decoding dependency is handled by the underlying video codec while composition dependency is handled in the PCC decoder. If streams are independently generated, they may follow a different coding order which may require extra handling in the decoder, such as adding buffers to store partially reconstructed point cloud frames.

FIG. 1 is a diagram showing a problem with existing solutions based on multiple independent bitstreams: competing dependencies between picture coding order and composition of reconstructed point cloud frames in solutions where no synchronization between independent encoders is provided. FIG. 1 depicts how composition dependencies may conflict with decoding dependencies if coding order between two streams is not consistent. For a geometry stream, there is no picture reordering; while for a texture picture, reordering follows a hierarchical 7B structure. However, for point cloud reconstruction, frames generated from the same source point cloud frame must be used. Both decoders will output pictures in the original input order; however, the texture decoder will incur larger delay due to reordering in the decoder. This means that output pictures from the geometry decoder need to be buffered.

In the current proposal considered by the MPEG group (ISO/IEC JTC1/SC29/WG11 MPEG), the following problems can be identified:
There is no explicit mechanism to enforce synchronization of separate encoders (for geometry and texture) which can lead to different picture reordering for the two bitstreams.
Current substreams are GOF-interleaved. This means that unless both substreams are in synchronization during GOF there needs to be a provision for extra decoded pictures buffers.
Current arrangements incur significant encoder delay where whole GOF of geometry picture needs to be coded before a bitstream can be send. The only solution to support low delay is to shorten GOFs which may impact overall compression performance.
There is no mechanism for how to signal to a decoder or a network device how to discard frames from the stream e.g. to support trick modes.

### SUMMARY

Certain aspects of the present disclosure and their embodiments may provide solutions to these or other challenges.

According to certain embodiments, there is provided a method for encoding a video image that includes combining a geometry image and a texture image associated with a single point cloud into a video frame. The video frame including the geometry image and the texture image is encoded into a video bitstream, and the video bitstream is transmitted to a receiver.

According to certain embodiments, there is provided a transmitter for encoding a video image that includes memory storing instructions and processing circuitry. The processing circuitry is configured to execute the instructions to cause the transmitter to combine a geometry image and a texture image associated with a single point cloud into a video frame. The processing circuitry is also configured to execute the instructions to cause the transmitter to encode the video frame including the geometry image and the texture image are encoded into a video bitstream, and to transmit the video bitstream to a receiver.

According to certain embodiments, there is provided a method for decoding a video image that includes receiving, from a transmitter, a video bitstream. The video bit stream comprises a video frame, which includes a geometry image and a texture image associated with a single point cloud into a video frame. The method includes decoding the video frame including the geometry image and the texture image.

According to certain embodiments, there is provided a receiver for decoding a video image that includes memory storing instructions and processing circuitry configured to execute the instructions to cause the receiver to receive, from a transmitter, a video bitstream. The video bit stream comprises a video frame, which combines a geometry image and a texture image associated with a single point cloud into the video frame. The processing circuitry is also configured to execute the instructions to cause the receiver to decode the video frame including the geometry image and the texture image.

Certain embodiments may provide one or more of the following technical advantage(s). For example, a technical advantage may be that geometry and texture images are bound into a single stream.

As another example, a technical advantage may be that certain embodiments leverage high level bitstream syntax of underlying 2D video codec (such as HEVC) for the point cloud data compression. According to certain embodiments, it specifies a single bitstream that can be decoded by an underlying video codec while auxiliary information can be passed as SEI (Supplemental Enhancement Information). As such, a technical advantage may be that a single bitstream does not create conflict between picture decoding and reconstruction point cloud composition dependencies. Rather, certain embodiments provide a solution to deliver all information required to reconstruct a point cloud sequence in a single bitstream.

As another example, a technical advantage may be that certain embodiments inherit support from the underlying video codec for delay modes and buffer size restrictions.

As still another example, a technical advantage may be that, by mandating use of tiles (or slices), certain embodiments remove dependency of substreams so they can be handled by separate decoder instances.

Still another advantage may be that certain embodiments inherit standard bitstream features such as discarding non-reference pictures or removing higher layer pictures without affecting legality of the bitstream.

Other advantages may be readily apparent to one having skill in the art. Certain embodiments may have none, some, or all of the recited advantages.

### BRIEF DESCRIPTION OF DRAWINGS

For a more complete understanding of the disclosed embodiments and their features and advantages, reference is now made to the following description, taken in conjunction with the accompanying drawings, in which:

FIG. 1 illustrates a problem with existing solutions based on multiple independent bitstreams;

FIG. 2 illustrates a current point cloud bitstream arrangement, according to certain embodiments;

FIG. 3 illustrates a proposed point cloud bit stream arrangement, according to certain embodiments;

FIGS. 4A-C illustrate examples of frame packing arrangement and use of tiles and slices, according to certain embodiments;

FIG. 5 illustrates an example system for video-based point cloud codec bitstream specification, according to certain embodiments;

FIG. 6 illustrates an example transmitter, according to certain embodiments;

FIG. 7 illustrates an example method by a transmitter for encoding a video image, according to certain embodiments;

FIG. 8 illustrates an example virtual computing device for encoding a video image, according to certain embodiments;

FIG. 9 illustrates an example receiver, according to certain embodiments;

FIG. 10 illustrates an example method by a receiver for decoding a video image, according to certain embodiments; and

FIG. 11 illustrates an example virtual computing device for encoding a video image, according to certain embodiments.

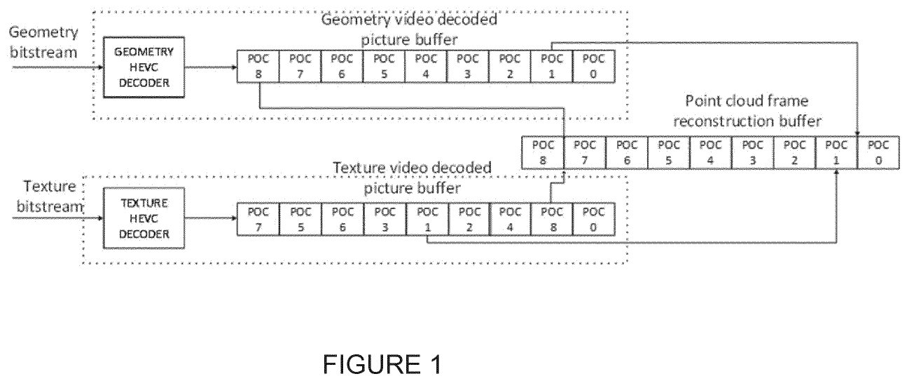

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Certain embodiments disclosed herein change the current way of handling geometry and texture data. For example, in the current system, there are two geometry and two texture images per a single point cloud. Two video images are results of two projections (near plane and far plane projection). The two video sequences are fed into separate video encoders resulting in two video bitstreams.

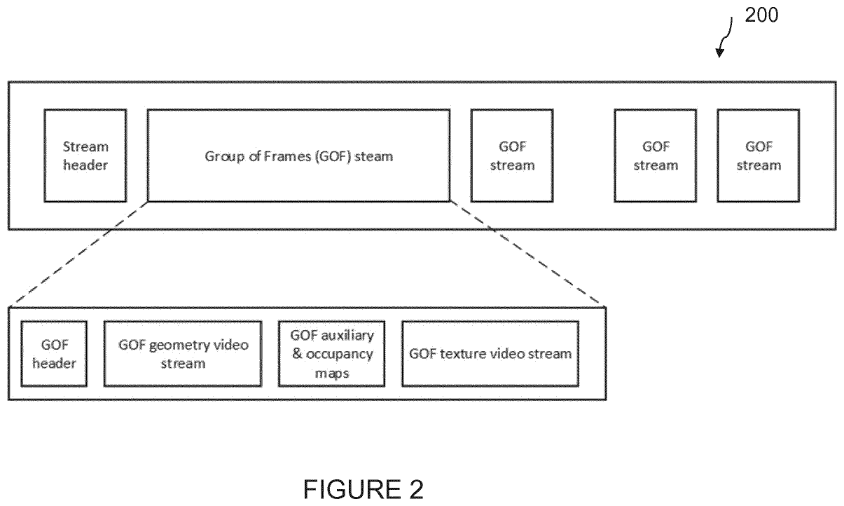

FIG. 2 illustrates a current point cloud bitstream arrangement 200, according to certain embodiments. As depicted, geometry and texture video streams are stored sequentially.

According to certain embodiments proposed herein, however, a pair of geometry and texture images are combined into a single frame. More specifically, the proposed solution advocates specification of a single bitstream for point cloud codec based on a 2D video codec bitstream such as HEVC. Using this approach, all video data may be represented in a single stream by frame packing geometry and texture information.

Such a combination of the geometry image and texture images in a single frame can be done with existing image packing arrangements in either side-by-side or top-bottom configuration. This creates a single video frame which can be fed into a single video encoder or multiple encoders if parallel coding tools are used. A frame packing arrangement can be signaled to the encoder using a Frame packing arrangement SEI message. Additional information such as occupancy map may be handled by associated SEI messages for each corresponding video frame. Further, according to certain embodiments, tiles (or slices) may be used to separate geometry and texture substreams so they can be handled separately by decoder. In particular, Motion-Constrained Tile sets SEI may be used to signal the restriction to the decoder. In order to ensure that sub-streams can be separately decoded, the encoder must ensure that prediction data for geometry and texture images is separate. Filtering across tiles boundaries (or slices if they are used in the arrangement) must be disabled. For example, in HEVC, the encoder may signal to the decoder that filters are not employed across boundaries by setting a slice_loop_filter_across_slices_enabled_flag. Another restriction may be related to preventing motion prediction across pictures if sub-streams are to be independently decoded. As such, according to certain embodiments, the encoder may signal the restriction to decoder using Temporal motion-constrained tile sets SEI message.

Using this approach, a following bitstream syntax can be supported:

while( ByteCount < bitstream_size_in_bytes){

group_of_frames_header( )
group_of_frames_video_stream( )

}

Where:
group_of_frames_header( )—contains a set of static parameters that reset decoder for each sequence (Group of Frames). This information could be regarding tools enabled in the signaled profile, maximal dimensions of video coding sequence after projection from point cloud to geometry and texture images, video codecs and profiles used.
group_of_frames_video_stream( )—this is a decodable video bitstream that has the following syntax:

Descriptor

group_of_frames_video_stream( ) {

| | |
|---|---|
| video_stream_size_in_bytes | u(32) |
| group_of_frames_video_payload( ) | |
| ByteCount += stream_size_in_bytes | |

}

Group_of_frames_video_payload( ) is the elementary video stream with Supplemental Enhancement Information messages.
In the video bitstream Sequence Parameter Set dimensions of a frame packed image are signaled.
Video bitstream signals usage of tiles (or slices)—minimum two are required as per packing arrangement. Tiles or slices cannot contain pixels belonging to both geometry and texture images.
Filtering across tiles (slices) boundaries is switched off
Frame Packing Arrangement SEI message is provided for each GOF. Changes to Frame Packing arrangement SEI can only apply at the beginning of each GOFs.
Temporal motion-constrained tile sets SEI message is provided at each GOF to prevent prediction from reference picture area between geometry and texture

In addition, as per current bitstream specification auxiliary and occupancy map information must be provided as SEI messages for each frame (each Access Unit):
PCC Frame Auxiliary Information (follows current syntax but send for each frame not for GOF)
PCC Occupancy Map Information

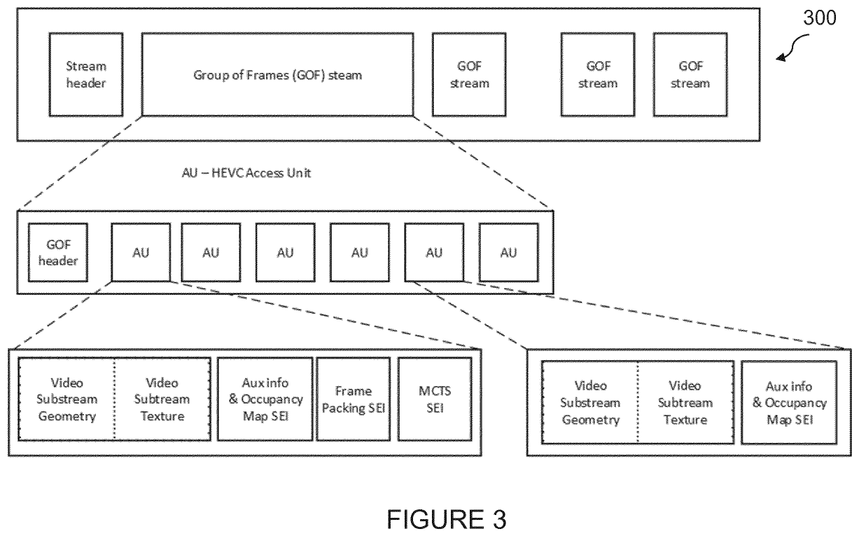

FIG. 3 illustrates a proposed point cloud bit stream arrangement 300, according to certain embodiments. An encoder must handle dealing with geometry and texture sub-images. HEVC standard provides parallel encoding tools that can encapsulate bits generated from each sub-image into a separate bitstream which can be extracted and decoded separately. Depending on the packing arrangement, the encoder should use slices (for top-bottom arrangement) or tiles (for top-bottom or side-by-side arrangement).

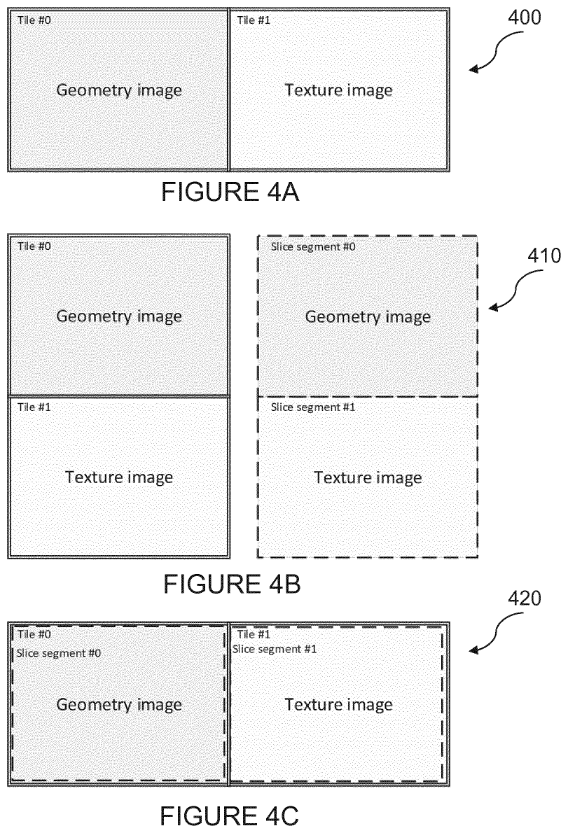

FIGS. 4A-C illustrate examples of frame packing arrangement and use of tiles and slices, according to certain embodiments. As depicted, FIGS. 4A-C show an example of the proposed bitstream syntax where each video picture is contained in HEVC access unit. Geometry and texture are carried in independent substreams. For each access using Auxiliary Info and Occupancy Maps are signaled to the decoder. At the beginning of each Group of Frames stream additional SEI signaling frame packing arrangement and motion-constrained tile sets are also signaled.

More specifically, FIG. 4A shows a side-by-side packing arrangement 400 where separate tiles are used to signal substreams corresponding to geometry and texture images, according to certain embodiments. As such, a geometry image is packed in a first tile, Tile #0, and a texture image is packed in a second tile, Tile #1.

FIG. 4B shows an example top-bottom packing arrangement 410 where either tiles or slices can be used to signal independent substreams corresponding to geometry and texture images, according to certain embodiments.

FIG. 4C shows an example top-bottom packing arrangement 420 where tiles are used to signal independent substreams for each image and slices are used to set independent coding parameters which are included in slice segment header.

Point cloud projected video frames do not have to adhere to any particular standard video format therefore tiles could be seen as a more flexible approach where encoder could choose packing in order to optimize for compression performance or to employ more efficient projection to minimize unoccupied blocks (CUs) in geometry and texture pictures.

To optimize encoding performance encoder implementation could use separate slices in each tile to have better control on slide-dependent parameters. This could be an important feature given that geometry and texture images are inherently different and may need different encoder parameters settings. Such parameters which could be set separately could be for instance deblocking filter control, Sample Adaptive Offset filter control, weighted prediction, or reference pictures to name a few.

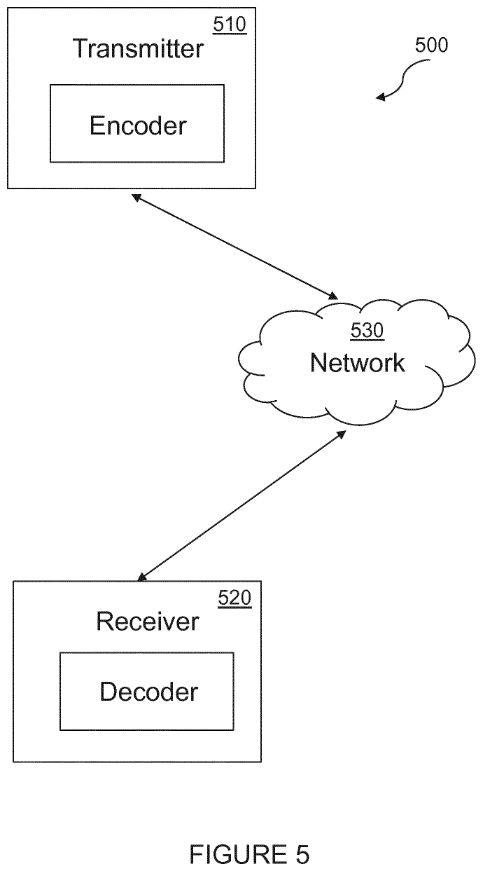

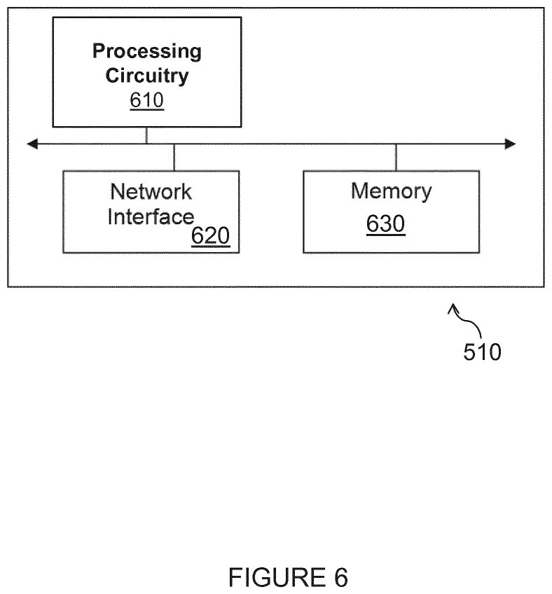

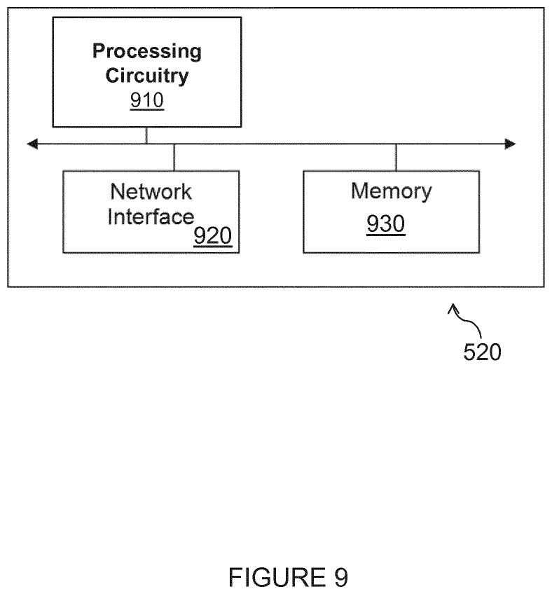

FIG. 5 illustrates an example system 500 for video-based point cloud codec bitstream specification, according to certain embodiments. System 500 includes one or more transmitters 510 and receivers 520, which communicate via network 530. Interconnecting network 530 may refer to any interconnecting system capable of transmitting audio, video, signals, data, messages, or any combination of the preceding. The interconnecting network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. Example embodiments of transmitter 510 and receiver 520 are described in more detail with respect to FIGS. 6 and 9, respectively.

Although FIG. 5 illustrates a particular arrangement of system 500, the present disclosure contemplates that the various embodiments described herein may be applied to a variety of networks having any suitable configuration. For example, system 500 may include any suitable number of transmitters 510 and receivers 520, as well as any additional elements suitable to support communication between such devices (such as a landline telephone). In certain embodiments, transmitter 510 and receiver 520 use any suitable radio access technology, such as long-term evolution (LTE), LTE-Advanced, UMTS, HSPA, GSM, cdma2000, WiMax, WiFi, another suitable radio access technology, or any suitable combination of one or more radio access technologies. For purposes of example, various embodiments may be described within the context of certain radio access technologies. However, the scope of the disclosure is not limited to the examples and other embodiments could use different radio access technologies.

FIG. 6 illustrates an example transmitter 510, according to certain embodiments. As depicted, the transmitter 510 includes processing circuitry 610 (e.g., which may include one or more processors), network interface 620, and memory 630. In some embodiments, processing circuitry 610 executes instructions to provide some or all of the functionality described above as being provided by the transmitter, memory 630 stores the instructions executed by processing circuitry 610, and network interface 620 communicates signals to any suitable node, such as a gateway, switch, router, Internet, Public Switched Telephone Network (PSTN), etc.

Processing circuitry 610 may include any suitable combination of hardware and software implemented in one or more modules to execute instructions and manipulate data to perform some or all of the described functions of the transmitter. In some embodiments, processing circuitry 610 may include, for example, one or more computers, one or more central processing units (CPUs), one or more microprocessors, one or more applications, and/or other logic.

Memory 630 is generally operable to store instructions, such as a computer program, software, an application including one or more of logic, rules, algorithms, code, tables, etc. and/or other instructions capable of being executed by a processor. Examples of memory 630 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 620 is communicatively coupled to processing circuitry 610 and may refer to any suitable device operable to receive input for the transmitter, send output from the transmitter, perform suitable processing of the input or output or both, communicate to other devices, or any combination of the preceding. Network interface 620 may include appropriate hardware (e.g., port, modem, network interface card, etc.) and software, including protocol conversion and data processing capabilities, to communicate through a network.

Other embodiments of the transmitter may include additional components beyond those shown in FIG. 6 that may be responsible for providing certain aspects of the transmitter's functionality, including any of the functionality described above and/or any additional functionality (including any functionality necessary to support the solution described above).

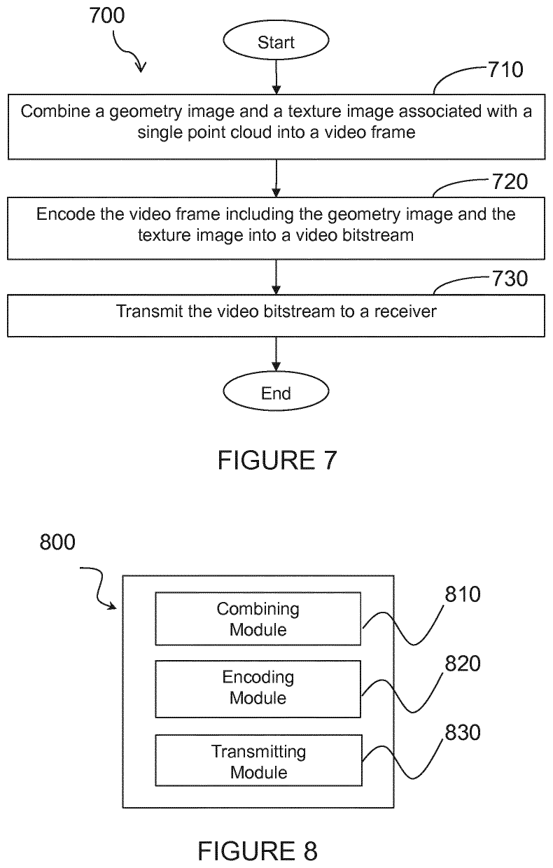

FIG. 7 illustrates an example method 700 by a transmitter 510 for encoding a video image, according to certain embodiments. The method begins at step 710 when the transmitter 510 combines a geometry image and a texture image associated with a single point cloud into a video frame. At step 720, the transmitter 510 encodes the video frame including the geometry image and the texture image into a video bitstream. At step 730, the transmitter 510 transmits the video bitstream to a receiver 520.

In a particular embodiment, the geometry image is a near plane projection and the texture image is a near plane projection. In another embodiment, the geometry image is a far plane projection and the texture image is a far plane projection.

In a particular embodiment, the geometry image includes a first projection and the texture image includes a first projection. For example, in a particular embodiment, the first projection of the geometry image may include a near plane projection and the first projection of the texture image may include a near plane projection. Alternatively, the first projection of the geometry image may include a far plane projection and the first projection of the texture image may include a far plane projection.

In a particular embodiment, the geometry image may include a second projection and the texture image may include a second projection. For example, in a particular embodiment, the first projection of the geometry image may include a near plane projection and the first projection of the texture image may include a near plane projection. Additionally, the second projection of the geometry image may include a far plane projection and the second projection of the texture image may include a far plane projection.

In a particular embodiment, combining the geometry image and the texture image may include using an image packing arrangement to place the geometry image in a first substream in the video frame and the texture image in a second substream in the video frame. The method may further include transmitting the image packing arrangement to the receiver.

In a particular embodiment, the image packing arrangement may be used to place the geometry image in a first substream in the video frame and the texture image in a second substream in the video frame. In a further particular embodiment, motion prediction may be constrained within the first and second substreams, and the method may further include transmitting a message to the receiver indicating that motion prediction is constrained and how the video bitstream is constructed.

In a particular embodiment, the image packing arrangement is a top-bottom image packing arrangement and the bitstream may include a plurality of tiles and/or slices. In another embodiment, the image packing arrangement is a side-by-side image packing arrangement and the bitstream comprises a plurality of tiles. In a particular embodiment, the transmitter may apply a first set of slice segment layer parameters to the geometry image and a second set of slice segment layer parameters to the texture image. For example, in a particular embodiment, the transmitter may apply a first set of slice segment layer parameters to the first substream including the geometry image and a second set of slice segment layer parameters to the second substream including the texture image.

In a particular embodiment, transmitter 510 may also transmit prediction data for the geometry image and the texture image to the receiver. The prediction data may be transmitted separately from the geometry image and the texture image.

In a particular embodiment, filtering across boundaries between the plurality of slices or the plurality of tiles is disabled, and the transmitter 510 may also transmit a message to the receiver 520 indicating that filtering across the boundaries is disabled. Additionally, or alternatively, motion prediction may be constrained within the video bitstream and/or selected tile sets. Transmitter 510 may transmit a message to the receiver 520 indicating that motion prediction is constrained and how the video bitstream and/or the tile sets are constructed.

In certain embodiments, the method for encoding a video image as described above may be performed by a computer networking virtual apparatus. FIG. 8 illustrates an example virtual computing device 800 for encoding a video image, according to certain embodiments. In certain embodiments, virtual computing device 800 may include modules for performing steps similar to those described above with regard to the method illustrated and described in FIG. 7. For example, virtual computing device 800 may include a combining module 810, an encoding module 820, a transmitting module 830, and any other suitable modules for encoding and transmitting a video image. In some embodiments, one or more of the modules may be implemented using processing circuitry 610 of FIG. 6. In certain embodiments, the functions of two or more of the various modules may be combined into a single module.

The combining module 810 may perform the combining functions of virtual computing device 800. For example, in a particular embodiment, combining module 810 may combine a geometry image and a texture image associated with a single point cloud into a video frame.

The encoding module 820 may perform the encoding functions of virtual computing device 800. For example, in a particular embodiment, encoding module 820 may encode the video frame including the geometry image and the texture image into a video bitstream.

The transmitting module 830 may perform the transmitting functions of virtual computing device 800. For example, in a particular embodiment, transmitting module 830 may transmit the video bitstream to a receiver 520.

Other embodiments of virtual computing device 800 may include additional components beyond those shown in FIG. 8 that may be responsible for providing certain aspects of the transmitter functionality, including any of the functionality described above and/or any additional functionality (including any functionality necessary to support the solutions described above). The various different types of transmitters 510 may include components having the same physical hardware but configured (e.g., via programming) to support different radio access technologies, or may represent partly or entirely different physical components.

FIG. 9 illustrates an example receiver 520, according to certain embodiments. As depicted, receiver 520 includes processing circuitry 910 (e.g., which may include one or more processors), network interface 920, and memory 930. In some embodiments, processing circuitry 910 executes instructions to provide some or all of the functionality described above as being provided by the receiver, memory 930 stores the instructions executed by processing circuitry 910, and network interface 920 communicates signals to any suitable node, such as a gateway, switch, router, Internet, Public Switched Telephone Network (PSTN), etc.

Processing circuitry 910 may include any suitable combination of hardware and software implemented in one or more modules to execute instructions and manipulate data to perform some or all of the described functions of the transmitter. In some embodiments, processing circuitry 910 may include, for example, one or more computers, one or more central processing units (CPUs), one or more microprocessors, one or more applications, and/or other logic.

Memory 930 is generally operable to store instructions, such as a computer program, software, an application including one or more of logic, rules, algorithms, code, tables, etc. and/or other instructions capable of being executed by a processor. Examples of memory 930 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 920 is communicatively coupled to processing circuitry 910 and may refer to any suitable device operable to receive input for the receiver, send output from the receiver, perform suitable processing of the input or output or both, communicate to other devices, or any combination of the preceding. Network interface 920 may include appropriate hardware (e.g., port, modem, network interface card, etc.) and software, including protocol conversion and data processing capabilities, to communicate through a network.

Other embodiments of the receiver may include additional components beyond those shown in FIG. 9 that may be responsible for providing certain aspects of the receiver's functionality, including any of the functionality described above and/or any additional functionality (including any functionality necessary to support the solution described above).

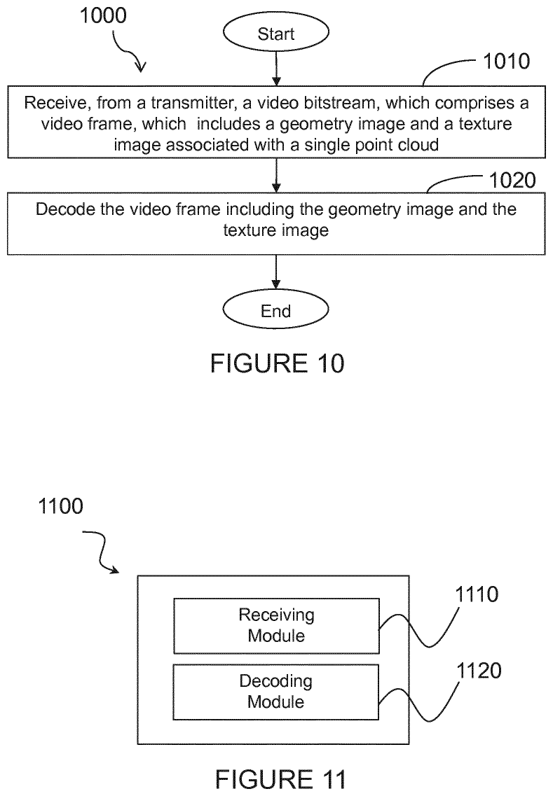

FIG. 10 illustrates an example method 1000 by a receiver 520 for decoding a video image, according to certain embodiments. The method begins at step 1010 when the receiver 520 receives, from a transmitter 510, a video bitstream. The video bit stream includes a video frame. A geometry image and a texture image associated with a single point cloud are combined into the video frame. At step 1020, the receiver 520 decodes the video frame including the geometry image and the texture image. In a particular embodiment, the geometry image is a near plane projection and the texture image is a near plane projection. In another embodiment, the geometry image is a far plane projection and the texture image is a far plane projection. In a particular embodiment, the geometry image may include a first projection and the texture image may include a first projection. For example, the first projection of the geometry image may include a near plane projection and the first projection of the texture image may include a near plane projection. Alternatively, the first projection of the geometry image may include a far plane projection and the first projection of the texture image may include a far plane projection.

In a further particular embodiment, the geometry image may include a second projection and the texture image may include a second projection. For example, the first projection of the geometry image may include a near plane projection and the first projection of the texture image may include a near plane projection. Additionally, the second projection of the geometry image may include a far plane projection and the second projection of the texture image may include a far plane projection.

In a particular embodiment, the receiver 520 may also receive, from transmitter 510, an image packing arrangement. According to the image packing arrangement, the geometry image may be packed in a first substream in the video frame and the texture may be packed in a second substream in the video frame. Receiver 520 may use the image packing arrangement to decode the video frame. In a particular embodiment, receiver 520 may receive a message that motion prediction is constrained within the first and second substreams.

In a particular embodiment, the image packing arrangement may be a top-bottom image packing arrangement and the bitstream may include a plurality of tiles and/or slices. In another particular embodiment, the image packing arrangement may be a side-by-side image packing arrangement and the bitstream may include a plurality of tiles.

According to certain embodiments, receiver 520 may receive, from the transmitter 510, prediction data for the geometry image and the texture image. The prediction data may be transmitted separately from the geometry image and the texture image. Receiver 520 may use the prediction data to decode the geometry image and the texture image.

In a particular embodiment, a first set of slice segment layer parameters may be applied to the first substream including the geometry image and a second set of slice segment layer parameters may be applied to the second substream including the texture image.

In a particular embodiment, a first set of slice segment layer parameters may be applied to the geometry image and a second set of slice segment layer parameters may be applied to the texture image.

According to a particular embodiment, receiver 520 may receive, from the transmitter 510, a message from the encoder indicating that filtering across boundaries between the plurality of slices or the plurality of tiles is disabled.

In certain embodiments, the method for decoding a video image as described above may be performed by a computer networking virtual apparatus. FIG. 11 illustrates an example virtual computing device 1100 for encoding a video image, according to certain embodiments. In certain embodiments, virtual computing device 1100 may include modules for performing steps similar to those described above with regard to the method illustrated and described in FIG. 10. For example, virtual computing device 1100 may include a receiving module 1110, a decoding module 1120, and any other suitable modules for decoding a video image. In some embodiments, one or more of the modules may be implemented using processing circuitry 910 of FIG. 9. In certain embodiments, the functions of two or more of the various modules may be combined into a single module.

The receiving module 1110 may perform the receiving functions of virtual computing device 1100. For example, in a particular embodiment, receiving module 1110 may receive, from a transmitter 510, a video bitstream. The video bit stream includes a video frame, which includes a geometry image and a texture image.

The decoding module 1120 may perform the decoding functions of virtual computing device 1100. For example, in a particular embodiment, decoding module 1120 may decode the video frame including the geometry image and the texture image.

Other embodiments of virtual computing device 1100 may include additional components beyond those shown in FIG. 11 that may be responsible for providing certain aspects of the receiver functionality, including any of the functionality described above and/or any additional functionality (including any functionality necessary to support the solutions described above). The various different types of receivers 520 may include components having the same physical hardware but configured (e.g., via programming) to support different radio access technologies, or may represent partly or entirely different physical components.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1.-52. (canceled)

53. A method for encoding a video image, the method comprising:
combining a geometry image and a texture image associated with a single point cloud into a video frame;
encoding the video frame including the geometry image and the texture image into a video bitstream; and
transmitting, to a receiver, the video bitstream.

54. The method of claim 53, wherein:
combining the geometry image and the texture image comprises using an image packing arrangement to place the geometry image and the texture image in the video frame, and
the method further comprises transmitting the image packing arrangement to the receiver.

55. The method of claim 53, further comprising:
transmitting, to the receiver, prediction data for the geometry image and the texture image.

56. A transmitter for encoding a video image, the transmitter comprising:
memory storing instructions; and
processing circuitry configured to execute the instructions to cause the transmitter to:
combine a geometry image and a texture image associated with a single point cloud into a video frame;
encode the video frame including the geometry image and the texture image into a video bitstream; and
transmit, to a receiver, the video bitstream.

57. The transmitter of claim 56, wherein:
combining the geometry image and the texture image comprises using an image packing arrangement to place the geometry image and the texture image in the video frame, and
the processing circuitry is configured to execute the instructions to cause the encoder to transmit the image packing arrangement to the receiver.

58. The transmitter of claim 56, wherein the processing circuitry is configured to execute the instructions to cause the transmitter to:
transmit, to the receiver, prediction data for the geometry image and the texture image.

59. A method for decoding a video image, the method comprising:
receiving, from a transmitter, a video bit stream, the video bit stream comprising a video frame, the video frame combining a geometry image and a texture image associated with a single point cloud into the video frame;
decoding the video frame including the geometry image and the texture image.

60. The method of claim 59, wherein the geometry image comprises a first projection and the texture image comprises a first projection.

61. The method of claim 60, wherein:
the first projection of the geometry image comprises a near plane projection and the first projection of the texture image comprises a near plane projection; or
the first projection of the geometry image comprises a far plane projection and the first projection of the texture image comprises a far plane projection.

62. The method of claim 60, wherein the geometry image comprises a second projection and the texture image comprises a second projection.

63. The method of claim 62, wherein:
the first projection of the geometry image comprises a near plane projection and the first projection of the texture image comprises a near plane projection; and
the second projection of the geometry image comprises a far plane projection and the second projection of the texture image comprises a far plane projection.

64. The method of claim 59, further comprising:
receiving, from the transmitter, an image packing arrangement, and
wherein decoding the video frame comprises using the image packing arrangement to decode the video frame.

65. The method of claim 59, further comprising:
receiving, from the transmitter, prediction data for the geometry image and the texture image; and
using the prediction data to decode the geometry image and the texture image.

66. A receiver for decoding a video image, the receiver comprising:
memory storing instructions; and
processing circuitry configured to execute the instructions to cause the receiver to:
receive, from a transmitter, a video bitstream, the video bit stream comprising a video frame, the video frame combining a geometry image and a texture image associated with a single point cloud into a video frame;
decode the video frame including the geometry image and the texture image.

67. The receiver of claim 66, wherein the geometry image comprises a first projection and the texture image comprises a first projection.

68. The receiver of claim 67, wherein:
the first projection of the geometry image comprises a near plane projection and the first projection of the texture image comprises a near plane projection; or
the first projection of the geometry image comprises a far plane projection and the first projection of the texture image comprises a far plane projection.

69. The receiver of claim 67, wherein the geometry image comprises a second projection and the texture image comprises a second projection.

70. The receiver of claim 69, wherein:
the first projection of the geometry image comprises a near plane projection and the first projection of the texture image comprises a near plane projection; and
the second projection of the geometry image comprises a far plane projection and the second projection of the texture image comprises a far plane projection.

71. The method of claim 66, wherein:
the processing circuitry is configured to execute the instructions to cause the receiver to receive, from the transmitter, an image packing arrangement, and
decoding the video frame comprises using the image packing arrangement to decode the video frame.

72. The receiver of claim 66, wherein the processing circuitry is configured to execute the instructions to cause the receiver to:
receive, from the transmitter, prediction data for the geometry image and the texture image; and
use the prediction data to decode the geometry image and the texture image.
